(19) United States
(12) Patent Application Publication
(10) Pub. No.: US 2024/0035989 A1
(43) Pub. Date: Feb. 1, 2024

(54) XRS INSPECTION AND SORTING OF PLASTIC CONTAINING OBJECTS PROGRESSING ON PRODUCTION LINE

(71) Applicant: SECURITY MATTERS LTD., D.N. Hevel Eilot (IL)

(72) Inventors: Haggai ALON, Kibbutz Naan (IL); Tehila NAHUM, Holon (IL); Nataly TAL, Nes Ziona (IL); Mor KAPLINSKY, Herzeliya (IL); Chen NACHMIAS, Tel Aviv (IL); Ron DAFNI, Tel Aviv (IL); Nadav YORAN, Tel Aviv (IL)

(21) Appl. No.: 18/258,450

(22) PCT Filed: Dec. 13, 2021
(86) PCT No.: PCT/IL2021/051482

§ 371 Date: Jun. 20, 2023

Related U.S. Application Data
(60) Provisional application No. 63/141,099, filed on Jan. 25, 2021.

(30) Foreign Application Priority Data
Dec. 20, 2020 (IL) 279615

(51) Int. Cl. G01N 23/207; G01N 23/223

(52) U.S. Cl. CPC G01N 23/2076; G01N 23/223; G01N 2223/0766; G01N 2223/623; G01N 2223/643

(57) ABSTRACT

An X-Ray-Spectroscopy (XRS) inspection station is presented for inspecting objects progressing on a production line. The XRS station comprises: at least one XRS inspection system each defining an XRS inspection region and performing one or more XRS inspection sessions on the object passing through the inspection region while progressing on the production line and generating XRS inspection data piece for said object. The XRS inspection system comprises at least one emitter, each producing X-Ray or Gamma-Ray exciting radiation to excite at least a portion of the object, and at least one detection unit that detects a response of said at least portion of the object to the exciting radiation and generates corresponding XRS inspection data pieces comprising data indicative of an XRS signature of marking(s) embedded in plastic material composition of the object, said data indicative of the XRS signature being informative of one or more conditions of plastic material composition in the object. The inspection system also includes an analyzer utility adapted to, generate, based on the XRS inspection data pieces, object status in association with identification data of the respective object. Also provided at the inspection station is a control unit which is adapted to generate, based on the object status data, sorting data in relation to said object for use at a sorting station of the production line.

### TECHNOLOGICAL FIELD AND BACKGROUND

The invention is generally in the field of inspection of objects using X-Ray Spectroscopy (XRS) by reading XR-responding markings embedded in the objects, and relates to automatic inspection technique suitable for inspecting objects progressing on a production line to properly sort the objects.

There is a growing need in the art for systems for sorting objects based on the parameters/conditions of material composition of the objects. It is known to utilize XRF-based techniques for object's material analysis, based on XRF marking embedded in or applied to the surface of the object, and sorting the objects accordingly.

For example, US 2019/193119, assigned to the assignee of the present application, describes an XRF-based technique for simultaneous identification of the presence of a marking composition in a plurality of objects, by modulating/varying the intensity of the excitation beam on the different objects and measuring the secondary radiation thereof. The XRF analyzer comprises a radiation emitter assembly adapted for emitting at least one X-Ray or Gamma-Ray excitation radiation beam having a spatial intensity distribution for simultaneously irradiating the plurality of objects; a radiation detector for detecting secondary radiation X-Ray signals arriving from a plurality of objects in response to irradiation of the objects by X-Ray or Gamma-Ray radiation, and providing data indicative of spatial intensity distribution of the detected data X-Ray signals on the plurality of objects; and a signal reading processor in communication with the detector, the processor being adapted for receiving and processing the detected response X-Ray signals to verify presence of the marking composition included at least one surface of each object of the plurality objects.

U.S. Pat. No. 10,207,296 discloses a material sorting system for sorting materials, such as scrap pieces composed of unknown metal alloys, as a function of their detected x-ray fluorescence. The x-ray fluorescence may be converted into an elemental composition signature that is then compared to an elemental composition signature of a reference material in order to identify and/or classify each of the materials, which are then sorted into separate groups based on such an identification/classification. The material sorting system may include an in-line x-ray tube having a plurality of separate x-ray sources, each of which can irradiate a separate stream of materials to be sorted.

### General Description

There is a need in the art for a novel and effective technique enabling X-Ray Spectroscopy (XRS) based automatic or almost-automatic inspection technique of various types of objects to determine properties of specific materials in the object to enable smart sorting and circular economy. In particular, there is a need for an automatic inspection station for inspecting the objects, while progressing on a production line, enabling sorting and certifying for grading of plastic and plastic waste-containing objects in order to properly manage plastic sorting process and recycling processes, e.g. to avoid extra recycling of plastics for further use, to grade the plastic, to loop count, measure amount of recycled content, type of polymer, and other quantification and qualification data.

It should be noted that XRS techniques suitable to be used in automatic inspection and sorting technique of the invention include: X-Ray Fluorescence (XRF) spectroscopy, as well as mini XRF and micro XRF (μXRF); and X-Ray diffraction (XRD) spectroscopy. All these XR-based techniques are known for use in elemental analysis, chemical analysis, to study the structure, composition, and physical properties of materials.

In the description below, all and any of such XR-based spectroscopy techniques are referred to as “XRF”, but it should be understood that this term should be interpreted broadly to cover all known suitable X-Ray based techniques.

The present invention provides an XRS based inspection technique for inspecting objects streaming on a production line (typically, being placed on a conveyor), which enables to sort the objects, based on conditions of plastic material compositions of the objects. More specifically, the invention provides for determining the plastic conditions based on a change in an XRF signature embedded in the plastic material from the original one (created in the plastic material of an object at the manufacturing stage) and/or a change in detectability of said signature.

Thus, according to one broad aspect of the invention, there is provided an X-Ray Spectroscopy (XRS) inspection station for inspecting objects progressing on a production line. The XRS station comprises: at least one XRS inspection system, an analyzer, and a control unit. The XRS inspection system is configured and operable to define an XRS inspection region and perform one or more XRS inspection sessions on the object passing through the inspection region while progressing on the production line and generate XRS inspection data piece for said object. The XRS inspection system comprises at least one emitter, each producing X-Ray or Gamma-Ray exciting radiation to excite at least a portion of the object, and at least one XRS detection unit configured to detect a response of said at least portion of the object to the exciting radiation and generate corresponding XRS inspection data piece comprising data indicative of an XRS signature of marking embedded in plastic material composition of the object, said data indicative of the XRS signature being informative of one or more conditions of plastic material composition in the object. The analyzer utility is configured and operable to, generate, based on the XRS inspection data piece, object status in association with identification data of the respective object. The control unit is configured and operable to generate, based on the object status data, sorting data in relation to said object for use at a sorting station of the production line.

According to another broad aspect of the invention, it provides an X-Ray Spectroscopy (XRS) method for inspecting objects progressing on a production line, the method comprising:

applying one or more XRS inspection sessions to the object passing through an inspection region defined by an XRS inspection station of the production line and generating XRS inspection data piece for said object, wherein the XRS inspection session comprises exciting at least a portion of the object by X-Ray or Gamma-Ray radiation and detecting a response of said at least portion of the object to the exciting radiation comprising data indicative of an XRS signature of marking embedded in plastic material composition of the object, said data indicative of the XRS signature being informative of one or more conditions of plastic material composition in the object;

based on the XRS inspection data piece, determining object status data, and recording said object status data in association with identification data of the respective object; and based on the recorded object status data, generating sorting data for use at a sorting station of the production line.

In some embodiments, the XRS inspection session comprises exciting at least portion of the object by the X-Ray or Gamma-Ray exciting radiation and detecting the response of said at least portion of the object to the exciting radiation, wherein the response is indicative of X-Ray Fluorescence (XRF) or X-Ray diffraction (XRD) induced by the exciting radiation interaction with the object.

In some embodiments of the invention, the determination of the object status may include the following:

analyzing the XRS inspection data piece and determining a deviation of the data indicative of the XRS signature from reference data characterizing reference marking of a respective plastic material composition in a respective object; and

analyzing said deviation according to predetermined criteria, and determining the object status data.

Alternatively, the determination of the object status comprises communicating the XRS inspection data piece to a central control system and receiving therefrom the corresponding object status.

In some embodiments, the determination of the object status includes the following:

analyzing the XRS inspection data piece and determining a deviation of the data indicative of the XRS signature from reference data characterizing reference marking of a respective plastic material composition in a respective object; and

communicating data indicative of said deviation to a central control system to cause the central control system to analyze said deviation according to predetermined criteria and generate data indicating of the corresponding object status; and receiving the object status data from the central control system.

In some embodiments, the determination of the object status data comprises applying machine learning based analysis to data indicative of the deviation of the identified XRS signature.

The condition(s) of the plastic material composition in the object to be analyzed may include a plastic recycling condition. The one or more plastic recycling conditions include one or more of the following: a number of recycling cycles that said plastic material has undergone prior to the inspection session; amount of recycling content; change in molecules' chain; change in molecules' concentration; and concentration of foreign materials introduced into product materials as a result of preceding recycling or use of the product.

The sorting data is typically indicative of whether and how the plastic material can be further used, i.e. can be used at all or not; a number of allowed recycling cycles; a type of object in which such plastic material after being recycled can be used.

In some embodiments, input object-related data with respect to the object arriving to the XRS inspection station is provided and analyzed, to generate operational data for optimizing said one or more XRS inspection sessions. For example, the input object-related data may include geometrical data about the object or the object of a certain type. The geometrical data may be used to determine/optimize position data for the inspection region with respect to a plane of object progression through the XRS station. This can be achieved by adjusting position data for one or more elements of an XRS inspection system at the XRS inspection station with respect to the object progressing through the XRS station to thereby optimize one or more parameters of the exciting radiation. The input geometrical data may be indicative of a thickness of a plastic layer to be inspected to identify the XRS signature of the marking.

Alternatively or additionally, the input object-related data may include data about an object type indicative of material composition of the object. This can be used to define spectral parameters of the exciting radiation optimized in accordance with expected marking embedded in the plastic material composition in the object.

The parameter(s) of the exciting radiation to be optimized may include at least one of power and exciting spot size to be applied to a predetermined location in the object.

In some embodiments, the input object-related data includes optical data generated at an optical inspection station of the production line upstream of the XRS inspection station.

In some embodiments, the input object-related data includes pre-stored user entry data.

The operational data may include data indicative of optimal configuration of emitting and detecting units of the XRS system, characterized by a number of emitters and a number of detectors to be involved in the inspection session and a relative accommodation between them and with respect to the object being inspected.

Alternatively or additionally, the operational data may include data indicative of an optimal speed of a relative displacement between the object and an XRS inspection system during the object's progression through the XRS inspection station.

In yet further broad aspect of the invention, it provides a control system for controlling X-Ray-Spectroscopy (XRS) inspection of objects. The control system is a computer system, which is connected to a computer network to communicate, via said network, with a plurality of XRS inspection stations at multiple production lines, and is in data communication with a central database manager. The control system is configured and operable to carry out the following:

in response to input data indicative of an XRS inspection data piece of an object in association with identification data of said object, utilizing pre-stored data in a central database for analyzing the XRS inspection data comprising data indicative of an XRS signature identified by a certain XRS inspection system with respect to marking embedded in said object, and determining object status data with respect to said object, based on one or more conditions of plastic material composition in the object derived from said data indicative of the XRS signature;

communicating the object status data to the respective XRS station; and

based on analysis of XRS inspection data pieces of related objects provided from more than one XRS inspection stations, optimizing data in the database.

The objects being subjected to the above-described automatic inspected while progressing on the production line are typically arranged in a spaced-apart relationship on a conveyor which moves them towards, through and out of the one or more inspection regions defined by one or more inspection stations.

The inventors have found that measurement and inspection of an object/sample from a preselected distance (that is preselected distances from the object to the one or more XR-based emitters and/or to the one or more detectors) can be achieved by positioning the inspection unit below the conveyor track/belts/rollers of translation system on which the samples/objects advance. This is associated with the following:

Conveyor based XRS sorting/identification systems often yield in-accurate/noisy measurements of the XRS responses from objects/materials. This affects the ability of the inspection systems to perform accurate and rapid sorting process. Such deficiencies are particularly emphasized in cases where the objects/materials to be sorted are marked with XRS marker compositions including atomic element markers of relatively low atomic numbers, or in cases where the material composition of the materials/objects themselves which are to be sorted, include atomic elements/compositions of high X-Ray or Gamma-ray absorbance or of high XRF emission, which may preclude the XRS responses from the XRS marking compositions of the objects, and thus yield noisy measurement and in-efficient or not accurate identification or sorting processes. Inspecting the objects from above or from the sides (namely, irradiating from above or the sides and detecting the response signal by a detector positioned also above or to the side of the object) appears to be ineffective for inspecting objects of different sizes and shapes since the distance from the sample (specifically the surfaces of the sample on which the inspected spot is located) to the emitter and detector may differ significantly from sample to sample. These differences may hinder correct analysis of the results obtained by the system and negatively affect the possibility to accurately identify and quantify materials and elements present in the sample.

The above drawbacks can be avoided by positioning the inspection unit below the conveyor track/belts/rollers of translation system on which the samples/objects advance.

Another advantage of the configuration in which the inspection system is situated below the inspected sample is the possibility to position the object/sample and the inspection unit in close proximity to each other, for instance down to distances of a few centimeters and even down to 1 mm or less from the inspected object/sample/material. This may be important wherein the inspection system is configured to detect light elements within the sample whose response signal may be significantly attenuated traveling through air.

The technique of the present invention is suitable for sorting/identification of various objects, marked/identifiable by XRS markers, which may be inherent part of the objects or added markers/marking compositions overlayed or embedded within the objects. Advantageously, the technique of the present invention facilitates reliable identification/sorting of such marked objects, even in cases where the objects have non-regular shapes (e.g., possibly objects or different sizes and shapes or amorphic shapes).

A situation wherein objects of different types, shapes and sizes are inspected may occur for instance during recycling processes of various products, and in particular recycling process of plastic products, packages, and materials. Plastic recycling processes generally require sorting and separating the products according to the specific material or polymer or combination of polymers comprising them.

As indicated above, advantageously placement of the inspection utility in close proximity to the inspected object/sample (even in cases where the objects' shapes are irregular) facilitates reliable identification/sorting of such marked objects/materials), also in cases where the XRS identifiable markers/marking-compositions of the objects/materials comprise relatively light atomic element markers, being serve as part of marking of the XRS marking composition.

In the scope of the present disclosure, the reference to atomic element markers, or atomic elements being part of the XRS marking composition, should be understood as referring to those atomic elements of the marking composition, whose XRS emission is an essential part of the identifiable XRS signature of the XRS marking composition (this is to distinguish these atomic elements, from other elements, which may be present in the marking composition, but whose XRS emission, if any, is not considered to form part of the identifiable signature of the marking composition. To this end, the present invention facilitates the use of marking compositions including one or more such light atomic element markers, with atomic number not exceeding 25 (e.g., with XRS electron energy not exceeding 6 keV).

The combined ability to identify, and possibly quantify, objects of non-regular sizes/shapes based on XRS identifiable marking compositions, which incorporate light atomic elements as part of the maker, is advantageous for sorting of various types of objects/materials in which incorporation of heavier atomic element markers as part of the XRS marking composition, may not be possible, either due to regulation, (such as FDA regulation which may prohibit incorporation of such heavier atomic elements in objects used for biological/human consumption—e.g. objects serving as food/drink vessels). For example, this combined ability of identifying XRS marking composition including light atomic elements, incorporated on non-regularly sized/shaped objects, is advantageous for identification and/or sorting and/or quantifying of plastic objects (such as recyclable plastics) which are marked by XRS marking compositions and whose sizes/shapes are amorphic.

To clarify this example, recyclable plastic objects to be sorted/identified may be characterized by one or more of the following:
a. Typically, the recyclable plastic objects to be sorted are solid objects having various different shapes and sizes;
b. The XRS markers/marking-compositions may be embedded in the plastic material of the recyclable plastic objects in substantially homogeneous manner.
c. The embedded XRS markers/marking-compositions may have typically low concentrations of the XRS responsive atomic elements yielding relatively week XRS signal per each region illuminated by the X-RAY/Gamma-Ray inspecting radiation spot. The concentration is depended on the element. For light elements typically it is required to use higher concentration than heavy atoms. For example, up to 100 ppm for heavy atoms (of atomic number above 25), up to 500 ppm for lighter atoms and above it for very light atoms (of atomic number not exceeding 20).
d. The atomic elements of XRS markers embedded in plastic materials, particularly those used for food/beverage packaging, are typically relatively light elements (e.g., of atomic number not exceeding 25), thus yielding only weak XRS signal, which is attenuated significantly while traveling in air.

It should be noted that, in some applications, positioning an XRS inspection module (e.g., radiation source and XRS spectral detector/spectrometer) on the sides of, or above, the conveyor system carrying the objects is needed because typically the conveyor system itself may be associated with significant XRS response, so it is preferable to distance the XRS inspection modules from the conveyor. Moreover, using this technique for sorting conventional solid objects marked by XRS is feasible. This is because: the XRF marker in such solid objects is typically configured with relatively high concentration of XRS responsive atomic elements which are confined at a relatively small volume of the marked object (be it the volume of the entire object being small, e.g., in case of a marked coin; or be it a specific location on the marked object at which the XRS marker is located). Accordingly, emission of a significantly intense XRS response signal from the marked object may be expected when irradiating the object, what allows obtaining an XRS response signal with sufficient SNR even with use of an instantaneous (not integrable) XRS detection scheme (e.g., using and X-Ray/Gamma-Ray illumination spot and/or instantaneous detection of the XRS response).

This is however not the case for sorting objects such as recyclable plastic elements or fluid materials, in which the homogeneously embedded XRF markers have typically low concentrations (the plastic objects are marked with light XRF responsive atoms providing only weak XRS response signals). Therefore, in order to obtain sufficient SNR of the XRS signal from such objects/materials with low concentrations of embedded XRS markers, the XRS inspection preferably follow an integrable scheme according to which materials/objects to be sorted continuously or intermittently irradiated over a time period while passing the region of the illumination spot, and the XRS response signals detected during prolonged time period are integrated to obtain a total XRS signal of sufficient SNR.

Thus, according to some aspects of the invention, the XRS inspection system or at least the XRS detector is placed below the conveyor so that the distance between the XRS inspection system and at least the bottom of the recyclable plastic objects to be sorted, may remain substantially constant and may be very small despite the variability in the objects' sizes, while possibly also defining substantially XRS transparent window in the conveyor system, above the XRS detector so that the XRS measurements will not be or precluded by the conveyor.

It should be understood that the present invention may be used and may be advantageous of identifying and/or sorting and/or quantifying marked objects made of various materials, including plastics, glass, metals, flame retardant materials embedded in any matrix and/or other materials, recycled or not. The term objects should be understood herein to cover solid items/aggregates as well as fluids/liquids having an identifiable, inherent, or added, XRS marking/composition. The present invention may be advantageous also for sorting objects/materials, containing for example flame retarders/inhibitors, in which the material composition of the objects themselves which are to be sorted, is highly absorptive to the X-Ray or Gamma-ray radiation used for the XRS inspection, as it may include inherent material elements/compositions, such as bromine, with high concentrations (e.g., above 1,000 ppm or even above 10,000 ppm).

Additionally, in some implementations of the present invention utilizes an integrable detection scheme (also referred to herein as gating). As indicated above, XRS inspection systems, such as Energy dispersive XRF (EDXRF) systems, include one or more emitters emitting X-ray radiation towards a sample/object (exciting atoms within the sample) resulting in the sample emitting a response X-ray signal, and one or more detectors for detecting the response signal. The emitters may be for example different emitters having/operating-with different parameters/properties, such as different voltages/filters/collimation parameters to enable identification multiple different elements in the XRS marking composition of the marked object simultaneously or successively. The region/area of a sample/object, which receives the incoming radiation from the one or more emitters and from which the response signal may reach the one or more detectors is referred to herein interchangeably as the inspected spot (the spot) or the inspection region. The data collected by the XRS inspection system, e.g., counts or count rates in each of the spectral channels (each channel corresponding to an energy band), is indicative (typically after analysis) of the presence and/or measure of the concentrations and/or relative concentrations of various materials/atomic-elements within the inspected sample/object. However, for XRS system according to the present invention, which inspecting) objects on a conveyor, and in particularly when the XRS detector is below the conveyor, the conveyor itself might emit XRF response in response to the exciting XRS radiation, thus introducing noise to the XRF measurement of the inspected object/sample, thus reducing the sensitivity, and accuracy of the measurement.

Accordingly, in such a system (particularly when the detector is below the conveyor) there is a need to reduce, the noise/background XRS measured due to excitation of the conveyor material.

To this end, the inspection station further includes a sensor unit including one or more sensors and an operational controller which provides an indication to the XRS inspection system relating to time an advancing object will reach the inspection region and the time period in which the object will be cross through the inspection region (e.g., that is the time period between the time in which the forward edge of the object will reach the inspection region spot and the time in which the backward edge of the object will leave the inspection region). The XRS inspection system thus operates according to the data provided by the sensor unit to conduct the inspection session and collect the measured data from the XRS detector only at time periods at which the inspected object is within the inspection region, thus enabling a more accurate, reliable, and efficient analysis of the data collected by the XRS inspection system.

In an example the sensor unit includes one or more infrared sensor which is able to detect whenever an object is present in a preselected area in the vicinity of the sensor unit and moving (on a continuous track such as a conveyor belt) towards the inspected spot. The sensor unit may be an imaging sensor(s) and may be associated with image/pattern recognition utility for detecting objects on the conveyor and identifying the size/extent that occupy on/above the conveyor. The sensor unit may therefore provide an indication when the object will reach the inspected spot. The sensor may also provide data indicating the size of the sample and when the sample will leave the inspected spot. In a different example the sensor unit may include one or more visual or other wavelength cameras, such as X-Ray, which may provide similar data as well as data relating to the size and shape of the sample. In another example the sensor unit may include X-Ray imaging sensors which may advantageously also provide data indicative of the material of the object, and more specifically indicative of whether the object is a metallic object (X-Ray absorptive) or none-metallic object, such as plastic.

The data from the sensor unit may be utilized to select and determine a scheme for the inspection of the incoming sample/object. In an example, the inspection session may include two or more phases. That is, in a first stage one set of parameters for the inspection system (including X-Ray tube voltage, and current and filters/beam-collimators in either the emitter and/or detector) is selected while in a second stage another set of parameters is selected. The portion of the sample inspected by in the first or second stage of the measurement may be set according to the size and/or shape of the inspected sample.

In another example a gated/integrable measurement scheme may be used in order to improve the SNR of the XRS measurements to thereby enable detection of relatively weak XRR signatures of marking compositions of objects/materials conveyed by the inspection system.

In a first implementation of this scheme, one or more sensor(s) (e.g. an IR or visual or X-Ray imaging sensor(s)/camera, a proximity-sensor, conveyor position sensor or any other suitable sensor) is/are used to detect the time period at which a certain object to be inspected passes through the inspection region, and operate the XRS inspection system to continuously or intermittently inspect that certain recyclable plastic object only during that time period at which it passes the inspection region. The data collected from each object corresponds to the area/volume the inspected region traverses within through the object/sample through the inspection region, and the duration of the inspection, which depends on the objects speed when moving through the inspection region/spot. The measurements may be conducted in time slots/bins during, and in coordination with, the movement of the object through one or more inspection regions. The measured data (e.g., counts per each spectral channel) may be collected for said time bins/slots, and may be thereafter summed/averaged to obtain the total XRS measured data of the object.

In a second implementation to the gated scheme, one or more sensor(s) (e.g. an IR sensor/camera/proximity-sensor, conveyor position sensor or any other suitable sensor) is/are used to detect the time period at which a the XRS transparent window of the conveyor crosses the inspection region, and operate the XRS inspection system to continuously or intermittently inspect that certain object during that time period at which the XRS transparent window preferably with the object, crosses the inspection region. By this scheme, the system reduces noise/clutter form the XRS measurements, which is associated with XRS responses from the conveyor materials. Also, here, in the similar manner, the system may be adapted to dynamically control the speed of the conveyor system to for example prolong the time period during which the XRS transparent window (e.g., with the object) crosses the inspection region and inspected. By this, the system actually prolongs the time the object is inspected without or with less background clutter/noise from the conveyor thus further improving the signal to noise and/or signal to clutter of the measurement. Moreover, vice versa, the system may be adapted to speed up the conveyor's speed at times the XRS transparent window is not within the inspection region, thus improving the yield of inspected objects by the system.

In any of the first and second implementations of this scheme, the spectral responses obtained during said period of continuous or intermittent inspection are then integrated to obtain the accurate XRS response signal with sufficient SNR. Both the first and second implementations of this scheme provide for reduction of noise from the XRS measurements and improvement in the SNR. The first and second implementations described above can also be combined so that the measurement of the object is conducted only at times both the object and the XRF transparent window are in the inspection region.

Thus, in some embodiments of the invention, the technique of the invention includes conducting a time integrative XRS measurement of the object carried by a conveyor through the inspection region. The time integrative XRS measurement may be for example conducted by carrying out the following: obtaining data indicative of a position of the conveyor, along an axis of movement thereof, or a position of at least one aperture defining an XRS-transparent window in the conveyor, and generating operational data for operating the XRS inspection session, in synchronization with a period of time, at which the position of the at least one XRS-transparent window crosses the inspection region. The XRS inspection system may be for example operated exclusively in synchronization with that period of time, i.e., by activating inspection during that period of time and deactivating the inspection at other times-before or after that period of time. Then, the spectral profile of the X-Ray-Fluorescence response during an integration period is integrated within the period of time at which the at least one XRS transparent window crosses the inspection region.

In some implementations conducting the time integrative XRS measurement further includes: sensing a position of said object, and operating the XRS inspection system in synchronization (e.g., exclusively in synchronization) with a time at which said object crosses the inspection region, such that the integration period is at least a part of the time period at which both the at least one XRS transparent window of the conveyor and the object, cross the inspection region.

Alternatively, or additionally, according to some embodiments of the present invention the method includes conducting a time integrative XRS measurement of the object carried by the conveyor, through the inspection region, by carrying out the following: sensing a position of said object; and operating the XRS inspection utility in synchronization (e.g., exclusively in synchronization) with a time period at which said object crosses the inspection region; and integrating the spectral profile of the X-Ray-Fluorescence response arriving from the object crossing through the inspection region during said time period at which said object crosses the inspection region.

The radiation emitter arrangement may include one or more emitters located above, below or aside the segment of the conveyor aligned with the inspection region where the object is located while being inspected, and emits radiation towards the inspection region.

In some cases, the conveyor itself may include materials having substantial XRF response. In such cases, the conveyor may be configured to define, at least at said one or more inspection regions, one or more XRS transparent windows defining regions of non or reduced XRS emissivity of the conveyor. For instance, the conveyor may include one or more conveyor tracks including one or more belts or roller-sets with one or more spacings in or between the one or more belts or roller sets. The XRS transparent windows may be defined by/at such spacings. Alternatively, or additionally the conveyor may include two or more of the conveyor tracks, with the one or more spacings XRS transparent windows, located/defined in or between the one or more belts or roller sets. Yet alternatively or additionally, the at least one belt or roller-set may be configured with one or more apertures defining the XRS transparent windows.

It should be noted that in some implementations the two-dimensional sizes of the one or more spacings/apertures defining the XRS transparent windows may be respectively equal or larger than a two-dimensional size of a cross-section of the exciting (emitted) beam. This provides that the exiting radiation beam may pass through the XRS transparent window without interacting with tracks, belts and/or roller-sets of the conveyor, thus avoiding XRS response from the tracks, belts and/or rollers of the conveyor.

For example, the conveyor may include at least one belt movable along at least one of the tracks and having the one or more apertures (e.g., perforations or windows) within the belt; the aperture(s) is/are thereby movable along with the belt of the conveyor to cross the inspection region. In some implementations the two-dimensional sizes of the aperture(s) of the at least one belt is/are elongated along an axis defining the direction of movement of the belt along the track. Accordingly, the lengths of the apertures along the axis are at least few times larger than a cross sectional size of the beam along that axis. This thereby enables to conduct a time integrative XRS measurement of the object carried by/on the belt through the inspection region. To this end, in some implementations the system also includes an inspection time controller and a signal integrator connectable to the inspection system, and configured and operable for conducting the time integrative XRF measurement of the object carried by/on said conveyor (belt) through the inspection region. The inspection time controller may operate as follows: obtain and process data indicative of a position of the conveyor (or a position of at least one aperture defining the XRS-transparent window), along the axis of movement of the conveyor and generate operational data for operating the inspection session, in synchronization with a period of time, at which the position of the relevant segment of the conveyor (position the aperture defining the XRS-transparent window) crosses the inspection region; and integrating the spectral profile of the XRS response arriving from the object crossing through the inspection region during an integration period within the period of time at which said relevant segment (XRF transparent window), with the object thereon, crosses the inspection region;

Accordingly, an integrated XRS response from the object during a time period, at which the conveyor segment does not interact with the X-Ray or gamma-ray radiation beam, is obtained. The integrated XRS response obtained in this way has typically relatively high signal to noise or signal to clutter ratio.

In some implementations the inspection time controller is adapted to operate the XRS inspection system in synchronization with the period of time, at which the position of the conveyor segment (aperture defining the XRS-transparent window) crosses the inspection region and disable/stop/halt operation of the inspection module at times at which other parts of the conveyor which are not-XRF-transparent cross the inspection region. Alternatively, or additionally, the controller may be adapted to operate the inspection system in synchronization with the time at which the position of the object crosses the inspection region and disable/stop/halt operation of the inspection module at other times. It should be understood that the disabling/stopping/halting the operation of the inspection module may include disabling at least an operation of the detector, and/or disabling at least the operation of the emitter.

Alternatively, or additionally, as indicated above in some implementation of the invention, the conveyor may include at least one roller-set arranged to define the XRS-transparent window as a spacing in between rollers thereof.

Yet alternatively or additionally, in some implementation of the invention the conveyor includes a movable belt for carrying the objects, where the belt is configured as a grid or mesh having the one or more apertures/perforations of sizes somewhat smaller than a cross-sectional size of the radiation beam, yielding reduced XRS clutter as response of interaction of the beam with materials of the mesh/grid of the belt. In some implementations the principal axes (e.g., directions of the wires/rods) defining said mesh/grid of the belt are aligned with diagonal orientation relative to a direction of movement of said belt so that the reduced XRS clutter has a substantially constant intensity and spectral profile, during movement of said belt across the inspection region. For example, the variability of the intensity of the spectral profile may not exceed a range of +/−15%.

The controller may be connectable to data storage (local or remote) for receiving reference data indicative of predefined XRS clutter expected from the conveyor. The controller may thus be configured and operable to receive data indicative of the detected XRS response from the inspection region, and subtract the predefined XRS clutter from the detected response to thereby obtain data indicative of the XRS response from the object, when the object is located at the inspection region. In some implementations the controller may be further adapted to integrate the secondary radiation associated with the response from the object over at least a part of a period of time during which the object crosses the inspection region.

Other embodiment and implementations of the present invention are exemplified by the figures and described in more details in the following detailed description of embodiments. A person of ordinary skill in the art will readily appreciated that the present invention as claimed is not limited by the examples provided herein and will readily appreciate various modifications for implementing the invention without departing of the present invention as claimed.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a block diagram of an exemplary XRF inspection station of the present invention for automatic inspection of objects progressing on a production line;

FIG. 2 is a flow diagram of XRF inspection method according to an embodiment of the invention;

FIG. 3A is a block diagram schematically illustrating a conveyor-based XRF inspection station according to some embodiments of the present invention;

FIGS. 3B to 3D are schematic illustrations of possible various configurations of conveyor-based inspection station according to embodiments of the invention, in which static or movable XRF transparent windows relative to inspection region(s) of the system are implemented with a roller-based conveyor and belt-based conveyor;

FIGS. 3E and 3F are schematic illustrations of embodiments of the conveyor-based inspection station according to the invention utilizing a plurality of inspection regions arranged along and travers to the movement direction of the conveyor respectively;

FIGS. 4A and 4B are schematic illustrations showing, respectively, perspective and side views, of an inspection station according to an embodiment of the present invention including a sensor unit configured to provide indication and data corresponding the presence and/or the size of a sample/object advancing towards the inspected region of the inspection utility; and

FIGS. 5A and 5B are schematic illustrations showing, respectively, side and top views, of an inspection station of according to yet another embodiment of the present invention.

### DETAILED DESCRIPTION OF EMBODIMENTS

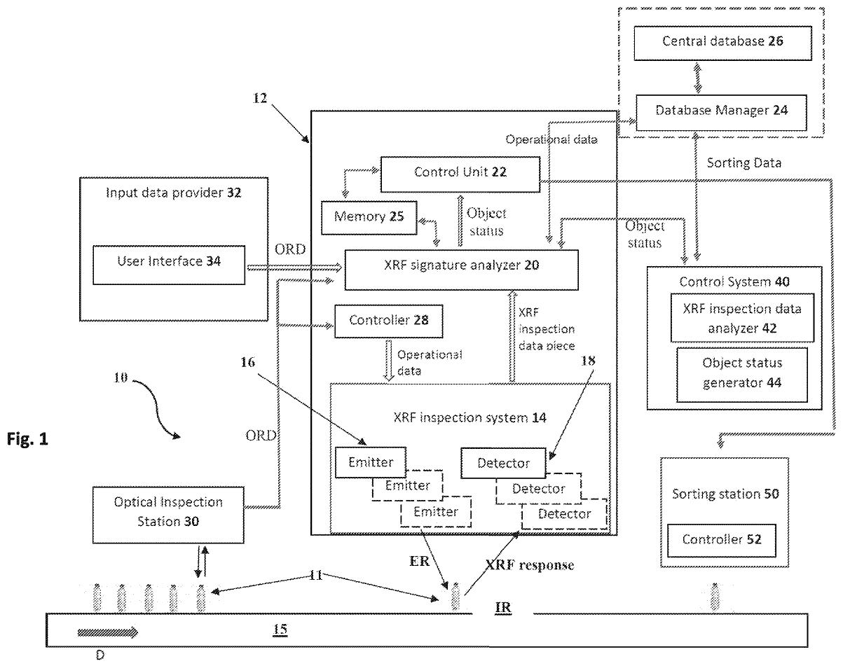

Referring to FIG. 1, there is schematically illustrated, by way of a block diagram, the configuration and operation of an XRF inspection station 12 of the present invention for inspecting objects progressing on a production line 10. Objects, generally at 11, may be arranged in a spaced-apart relationship on a conveyor 15 of any suitable known configuration, which transports a stream of objects 11 in a conveying direction D through successive stations along the production line 10. The XRF inspection station 12 successively inspects objects 11 while passing through an inspection region IR defined by the inspection station 12.

The inspection station 12 includes one or more XRF inspection systems—one such system 14 being schematically shown in the figure. The XRF inspection system 14 defines the inspection region IR, and is configured and operable to perform one or more XRF inspection sessions on the object 11 passing through the inspection region IR while progressing on the production line PL.

The inspection is aimed at identifying and determining the condition(s) of plastic material composition in the object according to one or more predetermined criteria. The inspection is based on identification of data indicative of XRF signature of XRF marking embedded in the plastic material composition of the object.

The XRF inspection system 14 includes a radiation source device including one or more emitters 16 producing X-Ray or Gamma-Ray exciting radiation ER to excite at least a portion of the object 11, and a detection device including one or more XRF detection units 18 including detectors and spectral analyzers. The detection unit is configured to detect an XRF response of the object 11 to the exciting radiation ER and determine a spectral profile thereof, and to generate XRF inspection data piece (measured data) comprising the data indicative of the XRF signature of identifiable XRF marking embedded in the plastic material composition of the object.

The elements of the XRF inspection system may be properly arranged with respect to an object progression plane, typically defined by the conveyor. For example, and in some embodiments preferably, at least one X-Ray detector is located beneath the section of the conveyor associated with the respective inspection region, and configured and operable for detecting the XRF response from the respective inspection region beneath/below said section of the conveyor. This enables to minimize a distance between the detector and objects moved by the conveyor through the inspection region and/or to maintain the distance to remain substantially fixed, irrespective of sizes of said objects, if and where needed. This technique will be described more specifically further below.

The so-determined data indicative of the XRF signature is informative of the condition of plastic material composition in the object according to predetermined criteria, e.g., is informative of the history of the plastic recycling(s) preceding the inspection by system 14. For the purposes of the present application, the criteria are selected to determine recycling conditions of the plastic material. Such conditions may include one or more of the following: a number of recycling cycles that said plastic material has undergone; amount of recycling content (change in molecules' chain; change in molecules' concentration; and concentration of foreign materials/impurities that may be introduced into the material/product during preceding recycling processes or regular use)). For a given plastic material, and possibly also its incorporation in given object(s), the plastic material condition in the object determines as to whether and how this material can be further used, e.g., can it be further recycled and if yes, a number of possible recycling cycles; can it be further used in different objects, etc.

For a given plastic material composition, each criterion may be defined by a respective characteristic (e.g., thresholding approach) or by a combination of different characteristics (and possibly respective weighting factors), enabling to properly classify the plastic material condition, and thus that of the object, for sorting purposes. The plastic material conditions are derived from determined deviation of the data indicative of the XRF signature read/measured by the system 14 from the reference XRF signature. The reference XRF signature may be the original XRF signature corresponding to original XRF marking initially created/embedded in the given plastic material for the purposes of identification/authentication of the plastic material composition. The status of the object containing the plastic material composition characterized by certain conditions is determined by data processing and analyzing of the XRF signature deviation using pre-stored deviation-relating database. It should be noted that data analysis for the purposes of determining the XRF signature deviation from the original one may take into account pre-stored data about the XRF reading/inspection system 12, as well as an XRF marking system used for creation of the XRF marking.

Thus, the XRF inspection system further includes an XRF signature analyzer 20 which is configured and operable to generate, based on the XRF inspection data piece, object status data OSD in association with identification data ID of the respective object. The object's ID may be readable on the object by any known suitable technique, e.g., optical system, e.g. at an optical inspection station 30 upstream of XRF inspection station; or supplied, in a controllable manner, by an external data provider 32. The operation of the analyzer 20 is described further below in more details.

Further provided in the XRF station 12 is a control unit 22 which is configured and operable to be responsive to the object status data OSD from the analyzer 20 to generate corresponding sorting data in relation to the respective object 11. This sorting data (e.g., together with the object status data and/or the identified XRF signature data) in association with the object, may be recorded in memory 25 for further use/analysis.

The sorting data can be used by a sorting station 50 to perform respective object classification action. For example, such sorting station 50 may be located on the production line 10 downstream of the XRF inspection station 12, and may include a sorting controller 52 in data communication with the XRF station control unit 22 or memory 25 or an external storage device where the sorting data is stored, as the case may be.

In some embodiments, the analyzer 20 is preprogrammed for analyzing the XRF inspection data piece received from the detection unit 18 and determining the object status data OSD. As described above, this includes analysis of the measured XRF signature over the signature-relating reference data (original XRF signature) and determining a change or degree of deviation of the measured signature from the reference one; and analysis of the so-determined degree of deviation based on the pre-stored deviation-relating reference data.

The analyzer 20 may be configured and operable to perform such two-step analyzing procedure. To this end, the analyzer 20 is configured for data communication with a database manager 24 which manages search engines for searching in a central database 26 as well as updates/optimizes data in the central database 26. The database and its manager may be associated with a remote computer system. The analyzer is thus appropriately equipped with a communication utility (not shown) of any known suitable type to communicate with the remote computer system via a computer network using any known suitable communication protocols.

The database may be a cloud-based system. In an example, the cloud-based system may be a distributed blockchain system, wherein a number of parties (e.g. manufacturer, recycler, retailer) have access to distributed ledger.

As further shown in the figure, in some embodiments, the analysis of the XRF inspection data may be performed by a remote central control system 40. More specifically, the control system 40 is a computer system, which communicates, via a computer network, with a plurality of XRF inspection stations at multiple production lines. The control system 40 is responsive to input data comprising data indicative of an XRF inspection data piece of an object in association with object's ID, and XRF station identification data. The system 40 includes an XRF data analyzer analyses 42 that analyzes the XRF data as described above and operates object status generator 44 to generate object status data OSD and communicate it to the corresponding XRF station.

Alternatively, the analysis results provided by internal analyzer 20 may be verified by the central control system 40.

Alternatively or additionally, the data analysis procedure may be distributed between the internal analyzer 20 and the central control system 40. In this case, for example, the XRF inspection data is first analyzed over XRF signature reference data by the analyzer 20, and the so-obtained signature deviation data is processed and analyzed at the central station 40. The central control system 40 is configured to communicate with the database system (manager) 24 to utilize the pre-stored reference data to apply artificial intelligence (AI) and machine learning based data processing.

The data analysis (being performed by the internal analyzer 20 and/or central control system 40) may utilize AI and machine learning data analysis. The principles of AI and machine learning technique are generally known and need be described in more details, except to note that such techniques typically utilize a training stage to train a machine learning model on corresponding measured data similar to XRF inspection data provided by various XRF inspection systems, and inference stage to apply the trained model to the measured data obtained in real measurements by the specific XRF inspection system.

Thus, the object status data (indicative of the plastic material conditions therein) may be provided by the internal analyzer 20 and/or external central control system 40. The results of the data analysis of related objects provided from more than one XRF inspection stations may be communicated to the database manager to update/optimize the reference data in the database.

Preferably, the XRF inspection system 14 is configured in a manner to enable optimization of its automatic operation towards a specific object to be inspected. To this end, the system 14 utilizes input object related data ORD indicative of material-related and/or geometrical parameters of the object 11.

Such object-related data ORD may be initially provided by any suitable user provider 32 via user interface 34, e.g., CAD data previously prepared and periodically supplied to the inspection system 14 in controllable manner, taking into account the speed/pattern of objects' stream progression on the conveyor (the speed of the conveyor may also be appropriately controlled by a respective controller). Alternatively, or additionally, the object-related data ORD may be obtained at the optical inspection station 30 upstream of the XRF inspection station.

The XRF inspection station 12 further includes a controller 28, which receives and analyzes the object-related data ORD and generates operational data to the XRF inspection system 14. Such operational data is used by the system 14 (e.g., its internal control circuit) to adjust an operational mode of the inspection session. The operational mode is defined by working parameters of the emitter(s) (e.g., spectral data) in accordance with the material-related of the object; and/or number of the emitter(s) and detector(s) involved in the inspection session and relative accommodation between them and with respect to the object to be inspected based on the material-related and geometrical data of the object. To this end, the XRF inspection system may be configured such as to enabling movement of its functional elements (emitter(s) and/or detector(s) with respect to one another and the inspection plane (object progression plane), as well as utilize multiple different spectral filters enable to use the selected one in the inspection session.

For example, the object related data ORD may include the object's shape and height, and position of the emitter(s) and/or detector(s) thus needs to be adjusted to optimize the readable XRF response. As described above and will be exemplified more specifically further below, at least the detector(s) of the XRF inspection system may be located below the conveyor plane, i.e. below the inspection plane defined by a surface of the conveyor on which the objects are located while being conveyed/moved through the inspection region. The object related data may include data indicative of a location and size of XRF marking containing region in the object (e.g. the plastic layer thickness), thus requiring adjustment of the operational parameters of the XRF system accordingly to achieve high efficiency in exciting the sample and the particular marker(s) which is/are to be read and in detecting the secondary radiation arriving from the sample.

In this regards the following should be noted. The amount of primary exciting X-Ray radiation of selected spectra that reaches the sample and is absorbed by the sample is to be optimized/maximized, and in particular the portion/fraction of that radiation that is absorbed by the element/marker that is to be measured. Also, the portion of the secondary radiation emitted from the measured element (the radiation emitted in response to the exciting radiation) that reaches the detector is to be optimized/maximized. Maximizing the amount of exciting radiation reaching the sample and being absorbed by the sample should be such that the primary radiation is confined as much as possible to a desired volume of the surface region on the sample (i.e., volume where the marker(s) is/are present or expected to be present). By this, the probability of absorbing the primary radiation by said volume on the surface of the sample is increased and the probability of penetration of the primary radiation through said volume of the surface region into the bulk of the sample is reduced.

Therefore, the emitter-sample-detector geometry might need to be adjusted, based on the operational data, so as to optimize the above factors. The XRF system with the optimized geometrical settings of the emitter(s) and the detector(s) relatively to the object increases the efficiency of the excitation and detection process, and thus increases the accuracy of the XRF signature identification.

The general principles of adjusting the XRF system geometry to optimize the excitation and detection, as well as some examples implementing the same, are described in WO 2018/05135, assigned to the assignee of the present application, and this publication is incorporated herein by reference.

The configuration and operation of the XRF system itself may for example be as those described in WO 2016/157185, WO 2018/051353, both assigned to the assignee of the present application and incorporated herein by reference.

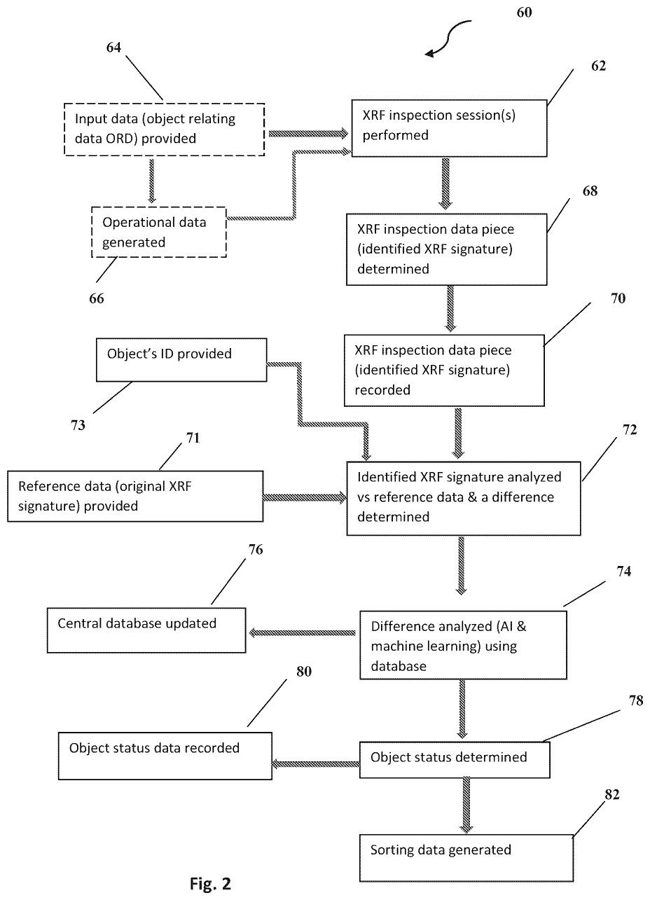

The XRF inspection method of the invention, which can be implemented by the above-described XRF inspection station 12, will now be described in more details with reference to FIG. 2 exemplifying a flow diagram, generally designated 60, of the inspection method.

While the objects progress on the production line, they successively arrive and pass through the XRF inspection station, where each object (or selective objects, as the case may be) undergoes one or more automatic inspection sessions (step 62). It should be understood that, practically, the objects are to be transported with a relatively high speed to meet the requirement of the production line throughput. The XRF inspection technique of the present invention provides for fast and effective automatic inspection modes, which may be adjustable to various types of objects and various types of plastic material compositions.

As described above, the XRF inspection session includes excitation of at least a portion of the object by X-Ray or Gamma-Ray radiation (e.g. of selected optimized spectra determined based on the object related data) and detection of a spectral profile of XRF response of the excited portion. Preferably, the inspection session(s) is/are implemented with an optimized inspection mode based on properly provided operational data (step 66).

As described above, the operational data may be determined in accordance with the object related data, e.g., obtained at the preceding station (e.g. optical inspection station)—step 64.

As also described above, the geometry of the arrangement of the emitter(s) and detector(s) and/or working parameters (power and spectral profile) of the emitter(s) are preferably optimized based on the object related data. As also described above, the geometry of the arrangement of the emitter(s) and detector(s) is preferably optimized based on the object related data. The arrangement data includes a number of emitters and a number of detectors involved in the inspection session and their relative accommodation. In order to properly optimize the XRF signature reading, for example two emitters may be concurrently used in the excitation (to increase the amount of primary radiation reaching the and being absorbed at a specific location in the object) in association with a single detection unit. Also, the emitter(s) may be properly moved towards and away from the object to create an excitation spot of a desired size at a desired location.

The XRF response data is analyzed to identify the XRF signature of detectable XRF marking and corresponding XRF inspection data piece (measured data) is generated—step 68. The identified XRF signature is analyzed (step 70) using properly provided/accessed reference data (step 71) and preferably also object's ID data duly provided (step 73) in association with the measured XRF response. The reference data may include data corresponding to original XRF marking created in and characterizing a respective plastic material. The data analysis includes determination of a difference between the identified XRF signature and the corresponding reference data, i.e. a change in/degree of deviation of the XRF signature from the reference data, and the deviation-relating data is recoded—step 72.

This change/deviation is further analyzed (e.g. using AI and machine learning technique) based on deviation-related reference data (pre-stored in central database), in accordance with predetermined criteria (step 74), and corresponding object status data is generated (step 78), and preferably properly recorded (step 80). The analysis results may be used to update the database (step 76). The object status data is used to generate sorting data with respect to said object (step 82).

For example, data in the database may include, for a given plastic material composition in a given object type, and for a given XRF inspection system and inspection mode, association between data describing the XRF signature deviation, measured on said object using said XRF system/inspection mode, and corresponding condition(s) of the plastic material composition and rules of its further use. Analysis of a plurality of XRS inspection results provides for updating and optimizing the database and its management.

As mentioned above, optionally, and in some embodiments preferably, the elements of the XRF inspection system may be properly arranged with respect to an object progression plane, typically defined by the conveyor. For example, at least one X-Ray detector may be located beneath the section/region of the conveyor associated with the respective inspection region, and is configured and operable for detecting the XRF response from the respective inspection region beneath/below said section of the conveyor.

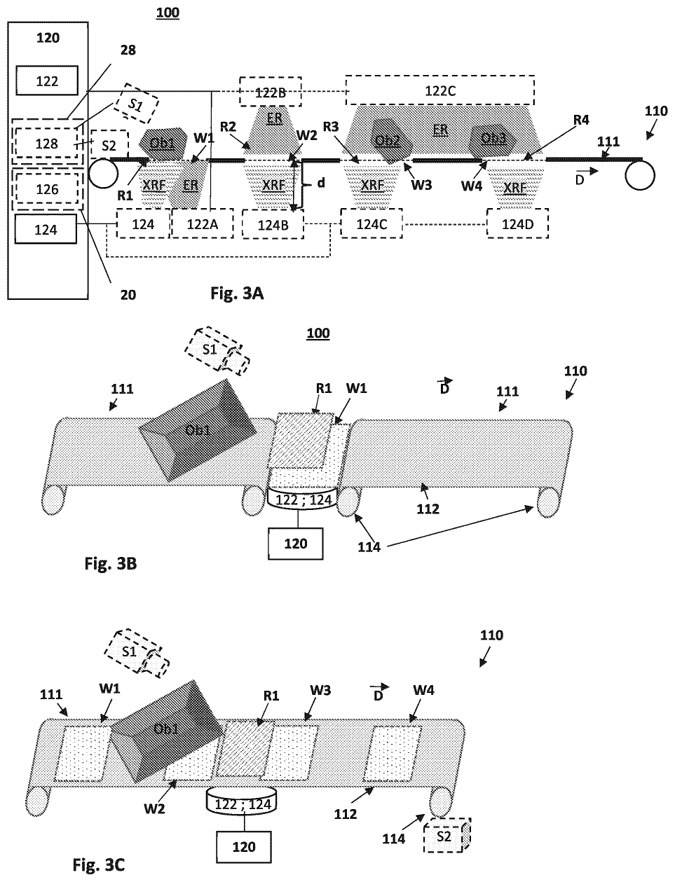

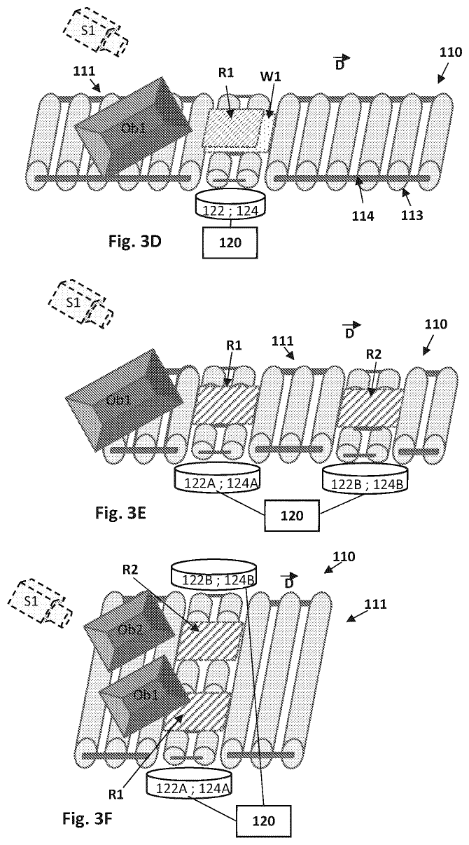

Reference is now made together to FIGS. 3A to 3F, in which FIG. 3A is a block diagram schematically illustrating various configurations of a conveyor based XRF inspection station 100 according to embodiments of the present invention in which at least one X-Ray detector is located beneath the section of the conveyer; and FIGS. 3B to 3F are schematic perspective view illustrations of various configurations of conveyor-based inspection system according to embodiments of the invention, having static or movable XRF transparent windows relative to inspection region(s) of the system and/or in which there are plurality of inspection regions arranged along and/or travers to the movement/translation direction of objects/materials by the conveyor of the system.

The XRF inspection station 100 is configured generally similar to the above-described inspection station 12 of FIG. 1, namely includes at least one XRF inspection system 120 (generally similar to system 12 in FIG. 1) defining at least one inspection region (IR in FIG. 1), and an XRF signature analyzer 20 (similar to that of FIG. 1), and also includes a conveyor system 110. The inspection system 120 includes an emitting arrangement 122 (16 in FIG. 1) and a corresponding detector arrangement 124 (18 in FIG. 1). Also provided in the inspection station 100 is a controller 28 (generally similar to that of FIG. 1).

In the non-limiting example of FIG. 3A, the inspection station 100 includes an array of spaced-apart inspection systems defining a corresponding array of inspection regions—fours such systems/regions R1, R2, R3, R4 being shown in the figure. Accordingly, the emitting and detector arrangements may include corresponding emitter-detector pairs, or two or more inspection systems may use a common emitter, as illustrated in FIG. 3A in a self-explanatory manner, where elements 122A, 122B and 122C designate emitters and elements 124A, 124B, 124C and 124D designate detectors.

The inspection station 100 is associated with a conveyor system 110 which includes at least one conveyor 111 configured and operable for moving objects, Ob1 to Ob3 (generally designated 11 in FIG. 1), through the inspection region(s). In the example of FIG. 3A, the objects are successively conveyed towards and through the inspection regions R1 to R4.

As also shown in FIG. 3A, the detector arrangement (multiple detectors 124A, 124B, 124C and 124D in this non-limiting example) is/are located below the respective inspection region(s) defined by the inspection system. In some embodiments, emitter(s) may also be located beneath the inspection region, as exemplified in FIG. 3A with respect to emitter 122A.

As exemplified in the figures, the conveyor 111 may include one or more conveyor tracks 114 including one or more belts 112 or roller-sets 113, or other mechanisms for conveying objects/material (continuous/aggregate or separate, solid, or fluid materials), as would readily be appreciated by those versed in the art.

In case the inspection station 100 includes more than one inspection regions, e.g., R1 and R2, the inspection regions R1 and R2 may be arranged as illustrated in FIG. 3E along the translation/movement direction D of the conveyor 111, to thereby enable successive inspection of the conveyed objects/materials several times. The emitters of the emitting arrangement 122 associated with the plurality of inspection regions R1 and R2 may be for example different emitters having/operating-with different parameters/properties, such as different voltages/filters/collimation parameters, as well as spectral characteristics, to enable identification multiple different elements in the XRF marking composition of the marked object successively.

Alternatively, or additionally, in case the system 100 includes more than one inspection regions, e.g., R1 and R2, the inspection regions R1 and R2 may be arranged as illustrated in FIG. 3F travers to the translation/movement direction D of the conveyor 111, to thereby enable concurrent/parallel inspection of several objects conveyed by the conveyor. Also, in this case, the travers emitters 122 of the plurality of inspection regions R1 and R2 may be for example different emitters having/operating-with different parameters/properties, such as different voltages/filters/collimation parameters as well as spectral characteristics to enable identification multiple different elements in the XRF marking composition of the marked object simultaneously.

The XRF inspection system/unit 120 includes at least one X-Ray or Gamma-Ray radiation emitter 122 and at least one X-Ray detector 124. In the non-limiting example of this figure, several optional radiation emitters 122A to 122C and several optional X-Ray detectors 124A to 124D are with various configurations relative to the conveyor 111 and to the inspection regions R1 to R4, there-above, are illustrated. As mentioned above, in various embodiments of the present invention, only one or more of said emitters and one or more of said detectors may be implemented in practice. The at least one X-Ray or Gamma-Ray radiation emitter 122 (e.g. any of 122A to 122C) is configured and operable for emitting an X-Ray or Gamma-Ray radiation ER towards at least one inspection region, e.g. R1, for exciting a secondary X-Ray-Fluorescence response XRF from at least one object Ob1 located at said inspection region R1. The one or more X-Ray detectors 124 (e.g. any of 124A to 124D), are configured and operable for detecting a spectral profile of the X-Ray-Fluorescence response XRF arriving from the one or more inspection region, e.g. R1, in response to the X-Ray or Gamma-Ray radiation ER and for generating XRF inspection data piece (measured data) comprising the data indicative of the XRF response arriving from the corresponding one or more inspection region. To this end it is understood that the inspection region(s) R1 to R4 designate regions close-to/above the conveyor 111 at which there is an overlap between areas exposed to the emitted radiation ER by the emitter(s) 122 (generally 122 designating any one or more of the optional plurality of emitters, e.g. 122A to 122C), and the areas from which secondary radiation response XRF can be detected by the XRF detector(s) 124 (generally 124 designating any one or more of the optional plurality of detectors, e.g. 124A to 124D). The XRF inspection system 120 may be for example configured and operable as Energy dispersive XRF (EDXRF) system.

Advantageously, in embodiments of the present invention, the detector(s) 124 of the XRF inspection system 120 is/are located beneath the conveyor 111 and more specifically beneath the section(s) thereof that are located at the respective inspection region(s) e.g., R1 to R4. This configuration facilitates to inspect objects, e.g., Ob1 to Ob2, having various shapes and sizes, while maintaining a-priori known distance d and which may be substantially fixed or controllably adjustable, to the inspected objects Ob1 to Ob2 from which XRF response XRF is expected (e.g., fixed/controllable distance d to at least the bottom parts of the objects).

Advantageously, a-priory information of the fixed or controllably-adjustable distance d to the inspected objects Ob1 to Ob2, or their bottom side, facilitates accurate analysis of the XRF responses XRF of the XRF marking compositions of the objects, Ob1 to Ob2 while enabling to mitigate XRF signals which may be emitted by other materials of the objects Ob1 to Ob2 or other materials in the vicinity of the inspection region(s) e.g. R1 to R4. This can be done for example by exploiting the fact that the data of the distance d is indicative of the expected estimated intensity ranges of the spectral signature of the XRF response of the XRF marking compositions of the objects Ob1 to Ob2 (e.g. indicative of the expected intensities or ranges thereof, of the spectral peaks in the XRF response of the XRF marking compositions), thus enabling to filter out spectral peaks exceeding these expected estimated intensity ranges and thereby remove at least part of the XRF noise/clutter which is not sourced by the XRF marking compositions, but possible sourced by other materials in the inspection regions (e.g. other materials of the inspected objects).

An additional advantage of the placement/arrangement of the X-Ray detector(s) 124 beneath the conveyor 111, being that such arrangement facilitates inspection of objects of various shapes and sizes, while maintaining/adjusting the distance d regardless of the objects' shapes/sizes.

Yet additionally, the placement/arrangement of the X-Ray detector(s) 124 beneath the conveyor 111 facilitates placement of the XRF detector(s) 124 at a relatively small distance d very close to at least the bottom parts of the objects Ob1 to Ob3, for example distance d of a few centimeters or even less. This in-turn enables the detection and analysis of the spectral response from XRF marking compositions which include, light atomic element(s) as marking elements whose XRF response is part of the XRF spectral signature of the XRF marking compositions. For example, this facilitates utilizing the XRF marking compositions which include marking atomic elements of relatively low atomic number, e.g., not exceeding 25.

With the above-described configurations, the conveyor based XRF inspection station 100 may advantageously be used and configured and operable for detecting XRF spectral signatures of XRF marking compositions embedded for example in plastic materials of the objects Ob1 to Ob3. For instance, the plastic materials of the objects Ob1 to Ob3 may include respective XRF marking compositions, each comprised of predetermined relative concentrations of one or more atomic element markers embedded in the plastic (these atomic element markers are also referred to herein interchangeably as XRF atomic element). As generally known, an XRF spectral signature of each XRF marking composition is associated with the predetermined relative concentrations of the one or more XRF atomic elements therein (e.g., the XRF detector(s) 124 are typically configured and operable as spectrometers capable of detecting spectral profile of the XRF response from the irradiated/inspected objects. To this end, utilizing the a-priori known, and possibly small distance d between the detector(s) 124 and the bottom of the objects Ob1 to Ob1 the conveyor based XRF inspection station 100 facilitates detecting the spectral profile of an XRF marking composition which is being embedded in plastic material, and which may include at least one light XRF atomic element, which emits in response to the radiation XR, only a weak, or air absorbable, XRF response signal. with energy of XRF photons not exceeding 6 kev and detecting said XRF signal from a distance d not exceeding a few centimeters from the object Ob1; and wherein said minimal distance d of the detector below the conveyor does not exceed said distance of the few centimeters to thereby enable accurate detection of the XRF spectral signature of each of said XRF marking compositions.

Thus, the XRF detector(s) 124 of the XRF inspection system 120 is/are located beneath respective section(s)/area(s) of the conveyor 111 thereof at the respective inspection region(s), e.g., R1 to R4. The XRF detector(s) 124 may be configured and operable for detecting said X-Ray-Fluorescence response XRF from said respective inspection region (e.g., R1 or R2) above said section of the conveyor, such that a minimal distance d between them and objects e.g., Ob1 moved by said conveyor 111 through the inspection region remains or can be adjusted to be substantially fixed irrespective of sizes of the objects. In general, the X-Ray or Gamma-Ray radiation emitter(s) 122 may be located anywhere about the inspection regions, e.g., above/below or on the sides of the inspection regions and the objects to be carried there-though by the conveyor 111. For instance, in the none-limiting example of FIG. 3A, the optional radiation emitters 122B and 122C are shown to be located above the conveyor 111 (and possibly above or on the sides of the inspection regions R2 to R4). The optional radiation emitters 122B and 122C are oriented such that that their radiation is directed towards the inspection region R2 to R4.

Having said that, in some embodiments of the conveyor based XRF inspection station 100, particular advantage is obtained by a configuration of the conveyor based XRF inspection system 100 with one or more of the X-Ray or Gamma-Ray radiation emitter(s) located below the conveyor 111. This is exemplified by the configuration of the optional radiation emitter 122A in the figure. As shown, the radiation emitter 122A is oriented such that that its radiation ER is directed towards the inspection region R1. In such configuration, both the radiation emitter 122A and the XRF detector 124A are located below the conveyor 111, from the same side of the conveyor 111 and the inspected object OB1 when it passes through the inspection region R1. This provides particular advantage for inspection of various objects whose material composition, apart from their XRF marking compositions, includes materials having relatively significant X-Ray or Gamma ray absorbance, which may preclude the XRF inspection particularly in cases where the radiation emitter 122 and XRF detector 124 are located from opposing sides of the inspected object. Materials/atomic-elements having relatively significant X-Ray or Gamma ray absorbance whose existence in objects may preclude the XRF inspection of XRF marking composition of objects, may include for instance relatively high concentrations of e.g. of above 1,000 ppm or even above 10,000 ppm of materials of atomic number above 25. For instance, objects, such as Ob1, made with flame retardants materials may include significant concentrations of Bromine (Br), which is characterized by relatively high absorbance of the X-Ray/Gamma-Ray radiation XR. Also, for example objects Ob1, made with non brominated flame retardants material, which for instance contain P (phosphorous) and/or Al and/or Mg, and/or Zn in high concentrations may be inspected/identified/sorted by the system of the present invention. In such cases, placement of the radiation emitter 122 above or on the sides of the conveyor 111, and placement of the corresponding XRF detector 124 below the conveyor 111, would result with substantial absorbance of the emitted (primary/exciting) radiation ER from the emitter 122, which could have otherwise induced XRF response for the XRF marking composition, and also result with substantial absorbance of the XRF response XRF from the XRF marking composition of the object Ob1. In such cases the Signal-to Noise or Signal-to-Clutter of the XRF inspection would be deteriorated.

Thus, some embodiments of the present invention are configured and operable to avoid/reduce such deterioration of the SNR avoid that and enable accurate and reliable inspection of XRF marking compositions incorporated in objects that include or are formed by materials/atomic-elements having relatively significant X-Ray or Gamma ray absorbance. This is achieved by configuring, both the radiation emitter 122A and the XRF detector 124A to be located below the conveyor 111, from the same side of the conveyor 111 such that they would be from the same side of the inspected object OB1 when it passes the inspection region R1. Accordingly, the accumulated traveling distance of the emitted radiation ER from the emitter 122A to the point(s) it excited/induces the XRF response XRF from the marking composition of the object Ob1, plus the traveling distance of the XRF response XRF to the detector, may be short (e.g. few centimeters in total, or about 2*D in the figure), and as a result the accumulated traveling distance through the object may be significantly smaller than the size/diameter of the object Ob1, thus reducing the absorbances of the X-Ray or Gamma-Ray radiation XR from the emitter 122A and the XRF response XRF by material of the object itself other than the XRF marking composition. Moreover, placement/arrangement of the X-Ray or Gamma-Ray radiation emitter 122A below the conveyor 111, enables to place the X-Ray or Gamma-Ray radiation emitter 122A in close proximity to the bottom side of the objects moved by the conveyor 111 through the inspection region R1, to thereby obtain a minimal/small distance d between the emitter 122A and the objects (e.g. distance of few centimeters or less), and this distance d may also remain substantially fixed irrespective of sizes of the objects and without movement of the emitter.

A difficulty in placement of the XRF detector 124, and possibly also the X-Ray or Gamma-Ray radiation emitter 122A below the conveyor 111 (directed to the inspection region above it) may arise due to the fact that conventional conveyors are often made with materials that may have substantial XRF response, or with materials, which are highly absorbing for the X-Ray or Gamma-Ray radiation XR from the emitter or absorbing the XRF response XRF from the object Ob1.

In some embodiments of the present invention, this difficulty is solved by utilizing a conveyor 111 formed of materials/atomic elements, which are not highly absorbing (substantially transmissive) to the primary X-Ray or Gamma-Ray radiation ER of the emitter 122 and/or substantially transmissive to the secondary XRF response XRF. In some embodiments the conveyor 111 is formed with materials, such as Aluminum alloy mesh or other light metal or carbon-based materials, whose self-emission of XRF is weak, or formed with materials whose self-emission of XRF is at spectral regimes different than that of the XRF marking compositions used for marking the objects which are to be inspected.

Alternatively, or additionally, in some embodiments of the present invention, this difficulty is solved by a configuration of the conveyor 111 with one or more XRF transparent windows W1 to W4 defining regions of non or low XRF emissivity and possibly with low absorbance of the X-Ray or Gamma-Ray primary radiation ER. Accordingly, when these windows W1 to W4 are located at the inspection region(s), e.g., R1 to R4, they practically do not disturb or interfere with the XRF inspection. The XRF transparent windows W1 to W4 may be for example implemented as spacings/apertures defined by either voids in the conveyor 111 (e.g. within/between its belts or rollers), or by defined materials of non or low XRF emissivity arranged in such spacings/apertures. In this regard the terms spacing or apertures should be considered as optical windows substantially transmissive to the wavelength ranges of the X-ray or Gama-ray exciting radiation ER and/or to the expected wavelengths of the XRF response XRF from the XRF marking compositions of the objects designated to be conveyed and identified by the inspection system 120.

To this end, as indicated above and illustrated in the self-explanatory FIGS. 3B to 3D, the conveyor 111 may include one or more conveyor tracks 114 with one or more belts 112 or roller-sets 113, and may have XRF transparent window(s) W1 located/defined by one or more spacings (voids or XRF transparent materials), between or within the one or more belts 112 (as shown in FIGS. 3B and 3C respectively) or between or within the roller sets as shown in FIG. 3D).

For example, the conveyor 111 may include two or more of conveyor tracks 114 carrying the belts or roller sets of the conveyor 111, and a spacing defining one or more of the XRF transparent windows W1 to W4, may be located in between the belts or roller sets of the tracks. In this case, as exemplified by FIGS. 3B and 3D, the position of an XRF transparent window W1 defined in this way, would be fixed relative to the inspection region(s) R1, while the object(s), e.g., Ob1, are passed/conveyed over it. Alternatively, or additionally for example, at least one belt or roller-set of the conveyor may be configured with one or more XRF transparent apertures defining one or more of the XRF transparent windows W1 to W4. In this case, if such aperture is defined in a movable belt, as exemplified in FIG. 3C, the position of an XRF transparent window W1 defined by the aperture, would be movable relative to the inspection region(s) R1.

Thus, as indicated above the XRF transparent windows may be defined as spacings/apertures/voids between the rollers or within the belt of a conveyor track, or by spacing/voids/apertures between belts/roller-sets to adjacent conveyor tracks. It should be understood that in some implementations, one or more of the XRF-transparent windows are only partially XRF transparent, since the spacings/voids/apertures, by which the XRF transparent windows are defined, are configured with somewhat smaller 2D sizes (widths/length) than the 2D cross section (widths/length) of XRF exciting radiation beam(s) ER or the effective cross-section of the XRF responses XRF from the inspected object. Yet the spacings/apertures/voids defining the windows are larger than regular spacing between rollers/belts of the conveyor, thereby yielding reduced XRF clutter of substantially fixed intensity and spectral profile, as response of interaction of the ER or XRF beams with materials of the rollers/belts in the vicinity of the spacings.

It should be noted that in some embodiments, the analyzer 20 of the XRF inspection station 10, 100 also includes a signal integrator configured and operable for conducting time integrative XRF measurement of the objects carried by/on through the inspection region(s). Also, in some embodiments, the controller 20 of the inspection station 10, 100 includes an inspection controller utility which manages various parameters/conditions of the inspection session, as will be described below. Although this is exemplified more specifically with respect to the conveyor based XRF station 100 in which the detector(s) is/are located beneath the conveyor segments, this aspect of the invention is not limited to this specific example.

Thus, as exemplified in the non-limiting example of FIG. 3A, the analyzer 20 includes a signal integrator 126 and the operation controller 28 includes an inspection time controller 128 each being connectable to, or being part of, the inspection system 120. The inspection time controller 128 and the signal integrator 126 configured and operable for conducting time integrative XRF measurement of the objects Ob1 to Ob3 carried by/on through the inspection region(s), e.g., R1 to R4.

In this connection, the phrase “time integrative XRF measurement” is used herein to designate XRF measurement of an object such as Ob1 that is carried out over a certain total time duration (a continuous period of time or intermittent periods) during which the inspected object is passed through one or more of the inspection region(s) (e.g. regions R1 to R4) and irradiated by the exciting X-Ray or Gamma ray radiation ER, and the XRF response XRF therefrom is detected by one or more of the detectors 124. This measurement scheme is integrative in the sense that XRF responses XRF obtained at different time slots of the total time duration of the measurement session, can be summed/integrated together to obtain a total measured XRF response which has generally a higher total signal to noise or signal to clutter ratio, than those of the individual XRF responses of the different time slots. This is for example because, a spectral profile of an XRF response XRF obtained from the XRF measurement in one time slot may have a “signal” part associated with the actual response of the XRF marking composition of the object Ob1, and “noise/clutter” part obtained for example from XRF response of other materials emitting XRF in response to the radiation XR. The noise part of the XRF response XRF may vary between different time slots (e.g., due to movement of the object Ob1 or movement of the conveyor 111 or due to inspection of the object at different inspection regions having different background XRF responses). Accordingly, the integration or summation of the XRF responses XRF obtained at different time slots when the object is located/move-through one or more of the inspection regions, yields a total signal to noise or signal to clutter which is generally higher than the SNR/SCR of the XRF measurements of each time slot.

Therefore, in some embodiments the inspection time controller 128 and the signal integrator 126 are configured and operable for implementing the above indicated “time integrative XRF measurement” scheme. To this end, the controller 128 generates control signal to operate the XRF inspection system 120 to carry out the XRF inspection session (for inspecting the object Ob1) only at time slots at which the object Ob1 crosses one or more of the inspection regions R1 to R4. To achieve that, the controller 128 may be connectable to a data source such as a sensor S1 and/or another data source capable of providing data indicative of time/time slots at which an object to be inspected, such as Ob1, crosses one or more of the inspection regions R1 to R4. The sensor S1 may be a camera, a proximity sensor or any other object position sensor configured and operable of sensing the position of the object at one or more of the inspection regions determine the time slots/periods at which the object is at least partially covered by the X-Ray or gamma-ray radiation beam ER. Such a sensor S1 may be part of inspection system 30 described above with reference to FIG. 1.

The inspection time controller 128 may be adapted to operate the inspection system/unit 120 in synchronization with the times (time slots) at which the position of the object crosses at least one the inspection regions R1 to R4, such as inspection regions R1 to activate or ensure activation of both the respective radiation emitter 122A and the respective XRF detector 124A associated with the respective region R1 to obtain the XRF measurement(s) for the time slot(s) at which the object Ob1 crosses the respective region R1. This may be performed for one or several inspection regions of R1 to R4 the object may cross when moved by the conveyor. In some implementations, the controller 128 may be adapted to disable/stop/halt the operation of the respective XRF detector 124A at times at which the inspected object Ob1 exits the respective region R1. to obtain the XRF measurement(s) for the time slot(s) at which crosses the respective region R1. Additionally, or alternatively, in some implementations, the inspection time controller 128 may be adapted to disable/stop/halt the operation of the respective X-ray or Gamma-ray emitter 122A at times at which the inspected object Ob1 exits the respective region R1.

Accordingly, a plurality of XRF measurements for the object at different time slots may be obtained by the XRF detector 124A, and these can be integrated/summed by the signal integrator 126 to yield a total/integrated XRF measurement having improved SNR/SCR as compared to the individual measurements. The signal integrator 128 is connectable to, or is part of, XRF inspection system 120 and is configured and operable for receiving (e.g. from the XRF detector(s) 124) the XRF responses (e.g. XRF spectral profiles) obtained from the plurality of XRF measurements conducted for the object Ob1 at the different time slots, and integrating or summing these measurements to obtain the total/integrated XRF measurement having improved SNR/SCR.

As described above, in some embodiments the XRF inspection station 10, 100 is configured and operable to output the XRF measurements conducted for the object Ob1 for processing by an external XRF processor.

Alternatively or additionally, in embodiments in which the conveyor include XRF transparent window(s) e.g. W1, which are movable relative to the inspection region(s), e.g. R1 (e.g. XRF transparent window(s) defined within a belt of the conveyor 111), the inspection time controller 128 may be configured and operable for implementing the above indicated “time integrative XRF measurement” scheme by operating the XRF inspection system 120 for performing XRF inspection at a certain inspection region, only at time slots at which the movable XRF transparent window(s) e.g. W1 crosses or is completely within the certain inspection regions R1. This provides means for reducing the noise/clutter XRF which may be obtained from the materials of the conveyor or belt thereof. To achieve that the controller 128 may be connectable to a data source, such as a sensor S2 which may be a part of the conveyor system 110, a camera or any other data source or belt-position sensor configured and operable for providing sensing data indicative of the position of the belt, or the position(s) of at least one XRF-transparent window, e.g., W1 defined therein, along an axis of movement of the conveyor/belt, to the controller 128.

In turn, the operational controller 28 may be configured and operable to carry out the following:
obtain the data indicative of a position of the conveyor/belt 111, or the position of at least the XRF-transparent window W1 relative to the inspection region(s), e.g., R1, along the axis of movement of the belt/conveyor;
operate the XRF inspection system 120, and more specifically the emitter(s) 122 and detector(s) 124 of the different inspection regions, e.g., R1 to R4, at, or in synchronization with, the period(s) of time (time slots), at which the position of the XRF-transparent window W1 crosses the respective inspection region(s). For instance, in some embodiments the controller 128 is adapted to operate the inspection module in synchronization with the period of time, at which the position of the XRF-transparent window crosses the inspection region, and disable/stop/halt operation of the inspection module at times at which other parts of the belt which are not-XRF-transparent cross the inspection region; and
thereby obtain (e.g., from the XRF detector(s) 124) the XRF responses (e.g., XRF spectral profiles) obtained from the plurality of XRF measurements conducted at the different time slots at which the XRF-transparent window(s) e.g., W1, is at one or more of the inspection regions R1 to R4, and at which therefore the level of noise/clutter in the XRF measurements is reduced (relative to cases where not the window W1 but the conveyor belt itself is in the inspection region).

These XRF responses (e.g., XRF spectral profiles) obtained from the plurality of XRF measurements conducted at any of the inspection regions, e.g., R1, one at the time slots at which the location of the XRF-transparent window(s) e.g., W1 is at the respective inspection region can then be integrated/summed/averaged (as described above by the internal or external signal integrator 126) to obtain the total/integrated XRF measurement having reduced noise/clutter and therefore improved SNR/SCR.

In this connection it should be understood that according to the present invention each of the above two different techniques for implementing the time integrative XRF measurement” scheme for improvement of the SNR/SCR, may be implemented independently of the implementation of the other technique. Namely, the time slots of the measurements by each inspection region may be synchronized with the location of an XRF transparent window W1 at the respective regions (e.g., regardless of the location there of the object to be inspected Ob1); or the time slots of the measurements by each inspection region may be synchronized with the location of the object Ob1 at the respective regions (e.g., regardless of the location there of an XRF transparent window W1). However in cases where the XRF transparent window(s) are movable relative to the inspection regions, particular advantage in reduction of noise/clutter and improvement of the SNR/SCR may be obtained in implementations of the system 100 of the present invention which combine these two techniques and operates the inspection system 120 to conduct XRF inspection at an inspection region such a R1 only at time slots which are synchronized to both the location object Ob1 (or at least part/significant-part thereof) at the inspection region R1, and the location of the XRF transparent window(s) W1 (or at least part/significant-part thereof) at that inspection region R1. This combined scheme might provide further improved SNR/SCR since it enables to integrate the spectral profiles of the X-Ray-Fluorescence response arriving from the object Ob1 crossing through the inspection region(s) R1 during an integration period, at which the XRF transparent window, with the object thereon, crosses the inspection region(s) R1; This is because during these times slots the object is within the operated inspection region e.g. R1 while the interaction of the materials of the conveyor/belt 111 with the XRF exciting radiation XR, is reduced (in case the size/dimension XRF transparent window(s) W1 is smaller than the inspection region R1) or totally avoided (in case the size/dimension XRF transparent window(s) W1 is equal or larger than the inspection region R1), thus yielding improved XRF response from the object Ob1 and reduced background noise from the conveyor 111.

In some implementations the time slots of the integration period are characterized in that when operating said X-Ray or gamma-ray radiation beam during said time slots, the X-Ray or gamma-ray radiation beam is fully within the XRF-transparent window W1 defined in the conveyor, and this does not interact with the conveyor or its belt and does not cause XRF emission from the conveyor or belt.

In some implementations the time slots of the integration period are further characterized in that during the object is positioned such that it is at least partially covered by the X-Ray or gamma-ray radiation beam in the inspection region by which it is inspected during at each time slot. Accordingly, the time slots may be set such that the object emits the X-Ray-Fluorescence response XRF during the entire integration period.

In some embodiments of the present invention the inspection time controller 128 is connectable to the conveyor system 110 and is configured and operable to dynamically adjusts the velocity of the conveyor system 110 according to the results/concurrent of the measurements of one or more of the objects. For example, the signal integrator 126 may performed the above indicated summing/integration of the measurements conducted on a certain object, continuously or intermittently during the passage of the object through the inspection regions. Accordingly, data indicative for instance of the rate at which the SNR/SCR of the measurement of the object is increased can be determined, possibly with dependence on whether the measurements are conducted view the XRF transparent windows or not. Accordingly, during the time the object is conveyed and inspected by the system, the signal integrator 126 may estimate the total time period required to obtain XRF measurement of an object with sufficient accuracy/SNR. For example, the signal integrator 126 may continuously compute/monitor the total XRF measured data collected for the past time slots/bins. In case the signal integrator 126 determines that the acquired signal (total counts) is too weak, or the rate of the signal acquisition is to slow, the inspection time controller 126 may be configured and operable to slow down the speed of the conveyor 111, so that the object will be inspected over a longer period of time (i.e. increasing the number of measurement time slots/bins) and/or to change the voltage/current of the X-Ray or Gamma-Ray emitter 122, or its filter properties or beam collimation size/parameters. Vice versa, in case the signal integrator 126 determines that the acquired signal (total counts) is/are sufficient for accurate inspection of the object, or the rate of the signal acquisition is adequate and above what is needed to yield accurate inspection of the object, the inspection time controller 128 may be configured and operable to speed up the conveyor 111, to improve the yield of inspected objects by the system 100. Moreover, as indicated above the rate of the signal acquisition from the object may be dependent on whether the object is inspected via an XRF transparent window or not. Accordingly, inspection time controller 128 may be configured and operable to dynamically control the speed of the conveyor 111 to prolong the time period during which the XRF transparent window (e.g., with the object) crosses the inspection region R1 and being inspected with reduced background clutter/noise from the conveyor, and/or speed up the conveyor's speed at times the XRF transparent window is not within the inspection region.

As for the sizes/shapes and/or relative arrangement of the XRF transparent windows e.g., W1 to W4, it should be noted that in some embodiments of the present invention the two-dimensional sizes of the one or more spacings/apertures defining the XRF transparent windows are respectively equal or larger than a two-dimensional size of a cross-section of the beam XR of the X-Ray or Gamma-Ray radiation emitted by one or more of the emitter(s) 122. In such embodiments the primary radiation beam ER may pass through the XRF transparent window W1 without interacting tracks, belts and/or roller-sets of the conveyor 111, thereby avoiding XRF response from the tracks, belts and/or rollers of the conveyor.

As for the shapes and/or relative arrangement of the XRF transparent windows e.g., W1 to W4, it should be noted that in some embodiments of the present invention, the conveyor includes a belt formed with one or more XRF-transparent window W1 to W4 (e.g., transparent apertures or perforations) defined within it and thereby movable together with the belt of the conveyor 111 to cross one or more of the inspection region(s) R1 to R4. In such cases, according to some embodiments of the present invention, the two-dimensional sizes of the one or more XRF-transparent windows W1 to W4 in the belt are elongated along an axis D defining the direction of movement of the belt along the track of the conveyor 111. Preferably, the two-dimensional sizes of the windows W1 to W4 are elongated such that the lengths of windows along the axis are at least few times larger than a cross sectional size of the X-Ray or Gamma-ray radiation beam XR along this axis V, to thereby enable to conduct the above indicated time integrative XRF measurement of the object with reduced interaction of the radiation with the belt (see for example the configuration of the mash belt of FIG. 3B).

It should be noted that in some embodiments in which the conveyor 111 includes a belt movable along tracks, the belt may be configured as a grid or mesh and the one or more XRF transparent windows W1 to W4 may be defined by one or more apertures (optical) or physical perforations within the belt. The sizes of such defined windows W1 to W4 (optical apertures or physical perforations) may be in some cases smaller than a cross-sectional size of the XRF exciting radiation beam XR, or smaller than an expected cross-section of the XRF response XRF. This yields a reduced XRF clutter as response of interaction of the beam with materials of the mesh/grid of the belt.

In some embodiments of the present invention, the principal axes (e.g., directions of the wires/rods) defining said mesh/grid of the belt are aligned with diagonal orientation relative to a direction of movement D of the belt 112. This is because such orientation of the mesh/grid of the belt the measured XRF clutter from the belt may have a substantially constant intensity and spectral profile when traversing the inspection region (e.g., since at all times the belt occupies a similar area at the inspection region. Accordingly, the variability of the noise intensity (being the spectral profile of the background clutter) from the belt may be reduced—e.g., to be fixed not exceeding a range of +/−15% during movement of said belt across the inspection region.

In some implementations the operation controller 28 (e.g. inspection time controller 128), or the analyzer 20, is/are connectable to a reference data provider utility, such as a reference data storage (e.g. database 25 in FIG. 1) for receiving data indicative of predefined XRF clutter expected from the conveyor (belt or rollers). The operation controller 28 or the analyzer 20 may be configured and operable to receive the XRF response detected by the detector, and subtract the predefined XRF clutter from the X-Ray-Fluorescence response to obtain data indicative of the X-Ray-Fluorescence response from the object with improved signal to noise/clutter.

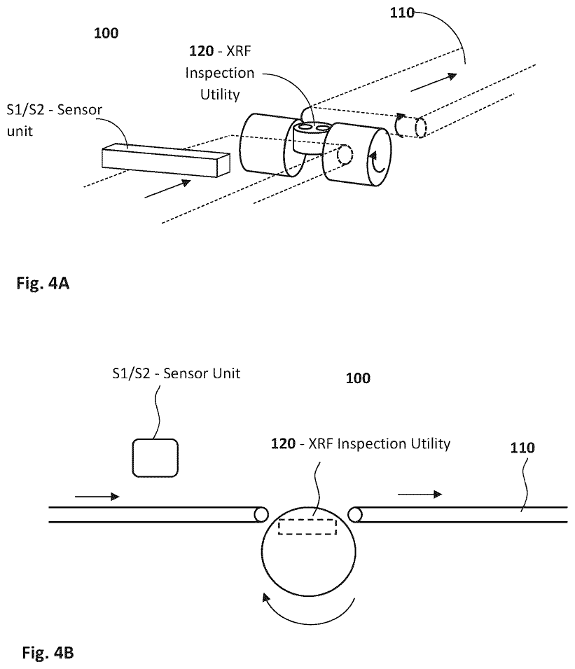

Reference is now made to FIGS. 4A and 4B exemplifying schematically (via perspective and side views) the relevant elements of an inspection station, in which the part of the inspection system including the emitter and detector is located in between two conveyors of the conveyor system, and a sensor unit is provided configured to provide indication data corresponding to the presence and/or the size of a sample advancing towards the inspected area (i.e., the spot) of the inspection utility. The sensor unit may also include an optical inspection module, for example visual, IR or X-Ray imaging (not specifically shown in the figure), for preliminary inspection of the marked object before the checking of the marking by the XRF inspection analyzer/utility. The optical inspection module may inspect the visual appearance of the marked object (for example verifying that the marking is invisible). The optical inspection system may inspect the marking by comparing an image of the marked object with a preselected image of an object that is stored in a database. Various features of the present invention as described with reference to FIGS. 3A to 3F above may also be implemented in the embodiment illustrated in FIGS. 4A and 4B.

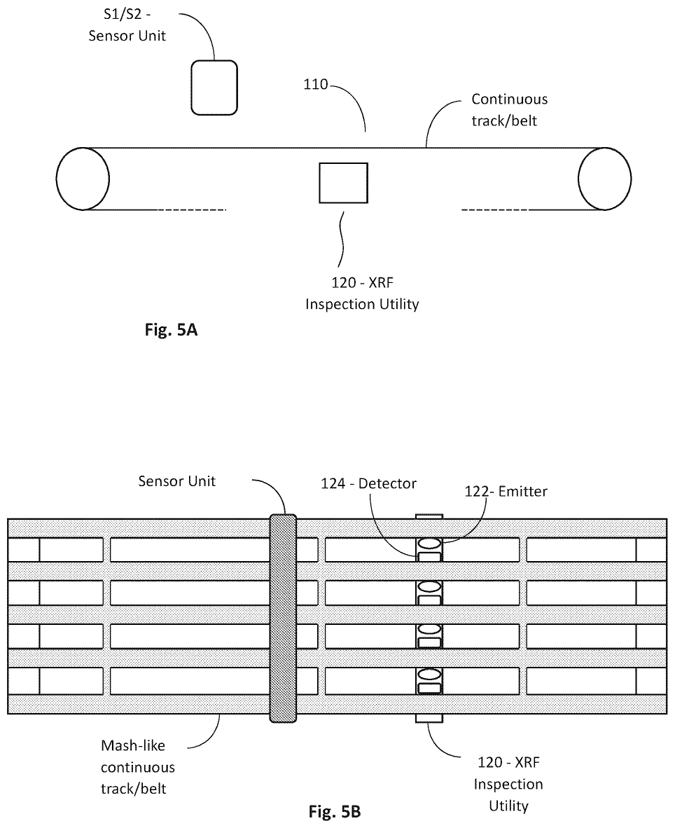

FIGS. 5A and 5B illustrate schematically side and top views of a conveyor based XRF inspection system according to an embodiment of the present invention, in which the inspection utility including the emitter and detector are located below the conveyor, and more specifically below a mash-like conveyor belt. In this example the sensor unit is configured to provide an indication and data corresponding to the presence and/or the size of a sample advancing towards the inspected area as described above. Various features of the present invention as described with reference to FIGS. 3A to 3F above may also be implemented in the embodiment illustrated in FIGS. 5A and 5B.

1-56. (canceled)

57. X-Ray-Spectroscopy (XRS) inspection station for inspecting objects progressing on a production line, the XRS station comprising:
at least one XRS inspection system, the XRS inspection system being configured and operable to define an XRS inspection region and perform one or more XRS inspection sessions on the object passing through the inspection region while progressing on the production line and generate XRS inspection data piece for said object, wherein the XRS inspection system comprises at least one emitter, each producing X-Ray or Gamma-Ray exciting radiation to excite at least a portion of the object, and at least one detection unit configured to detect a response of said at least portion of the object to the exciting radiation and generate corresponding XRS inspection data pieces comprising data indicative of an XRS signature of marking embedded in plastic material composition of the object, said data indicative of the XRS signature being informative of one or more conditions of plastic material composition in the object;
an analyzer utility configured and operable to, generate, based on the XRS inspection data pieces, object status in association with identification data of the respective object; and
a control unit configured and operable to generate, based on the object status data, sorting data in relation to said object for use at a sorting station of the production line.

58. The inspection station according to claim 57, wherein said analyzer is configured and operable to analyze the XRS inspection data pieces and determine a deviation of the data indicative of the XRS signature from reference data characterizing reference marking of a respective plastic material composition in a respective object; and to analyze said deviation according to predetermined criteria, and determine the object status data.

59. The inspection station according to claim 57, wherein said analyzer is configured and operable to carry out the following: analyze the XRS inspection data pieces and determine a deviation of the data indicative of the XRS signature from reference data characterizing reference marking of a respective plastic material composition in a respective object; communicate data indicative of said deviation to a central control 30 system as a request to receive from said central control system data indicative of corresponding object status; and in response to receipt from said central control system the data indicative of the object status, operate the control unit to generate the sorting data.

60. The inspection station according to claim 58, wherein said analyzer is configured and operable to perform machine learning based analysis of data indicative of the deviation of the identified XRS signature.

61. The inspection station according to claim 57, wherein said sorting data is indicative of whether and how the plastic material can be further used.

62. The inspection station according to claim 57, further comprising an operational controller configured and operable to analyze input object-related data with respect to the object arriving to the XRS inspection station, and generate operational data for optimizing said one or more XRS inspection sessions.

63. The inspection station according to claim 62, wherein said input object-related data comprises geometrical data about the object, said operational data comprising position data for the inspection region with respect to a plane of object progression through the XRS station.

64. The inspection station according to claim 62, wherein said input object-related data comprises data about an object type indicative of material composition of the object, the operational data comprising spectral parameters of the exciting radiation optimized in accordance with expected marking embedded in the plastic material composition in the object.

65. The inspection station according to claim 64, wherein said one or more parameters of the exciting radiation to be optimized includes at least one of power and exciting spot size to be applied to a predetermined location in the object.

66. The inspection station according to claim 65, wherein said input geometrical data is indicative of a thickness of a plastic layer to be inspected to identify the XRS signature of the marking.

67. The inspection station according to claim 62, wherein said operational data includes data indicative of optimal configuration of emitting and detecting units of the XRS system, characterized by a number of emitters and a number
of detectors to be involved in the inspection session and a relative accommodation between them and with respect to the object being inspected, and/or wherein the operational data includes data indicative of an optimal speed of a relative displacement between the object and the XRS inspection system during the object's progression
through the XRS inspection station.

68. The inspection station according to claim 62, wherein said input object-related data comprises optical data generated at an optical inspection station upstream of said XRS inspection system.

69. The inspection station according to claim 62, wherein said input object-related data comprises pre-stored user entry data.

70. The inspection station according to claim 57, wherein said XRS inspection session comprises exciting at least portion of the object by the X-Ray or Gamma-Ray exciting radiation and detecting the response of said at least portion of the object to the exciting radiation, said response being indicative of X-Ray Fluorescence
(XRF) or X-Ray diffraction (XRD) induced by said exciting radiation interaction with the object.

71. The inspection station according to claim 57, further comprising a conveyor having a surface for carrying the object being inspected while moving said object to and through said at least one inspection region.

72. A control system for controlling X-Ray-Spectroscopy (XRS) inspection of objects, the control system being a computer system, which is connected to a computer network to communicate, via said network, with a plurality of XRS inspection stations at multiple production lines, and is in data communication with a central database manager, the control system being configured and operable to carry out the following:
in response to input data indicative of an XRS inspection data piece of an object in association with identification data of said object, utilizing pre-stored data in a central database for analyzing the XRS inspection data comprising data indicative of an XRS signature identified by a certain XRS inspection system with respect to marking embedded in said object, and determining object status data with respect to said object, based on one or more conditions of plastic material composition in the object derived from said data indicative of the XRS signature;
communicating the object status data to the respective XRS station; and based on analysis of XRS inspection data pieces of related objects provided from more than one XRS inspection stations, optimizing data in the database.

73. An X-Ray-Spectroscopy (XRS) inspection method for inspecting objects progressing on a production line, the method comprising:
applying one or more XRS inspection sessions to the object passing through an inspection region defined by an XRS inspection station of the production line and generating XRS inspection data piece for said object, wherein the XRS inspection session comprises exciting at least a portion of the object by X-Ray or Gamma-Ray radiation and detecting a response of said at least portion of the object to the exciting radiation comprising data indicative of an XRS signature of marking embedded in plastic material composition of the object, said data indicative of the XRS signature being informative of one or more conditions of plastic material composition in the object; based on the XRS inspection data piece, determining object status data, and recording said object status data in association with identification data of the respective object; and based on the recorded object status data, generating sorting data for use at a sorting station of the production line.

74. The XRS inspection method according to claim 73, wherein said determining of the object status comprises:
analyzing the XRS inspection data piece and determining a deviation of the data indicative of the XRS signature from reference data characterizing reference marking of a respective plastic material composition in a respective object; and analyzing said deviation according to predetermined criteria, and determining the object status data.
